(19) United States
(12) Patent Application Publication
(10) Pub. No.: US 2004/0225620 A1
(43) Pub. Date: Nov. 11, 2004

(54) Systems and methods for valuing professional services

(76) Inventors: Alfred L. Faustino, Arlington, TX (US); Michael E. Immler, Duncanville, TX (US)

Correspondence Address: Ortiz & Lopez, PLLC, ATTN: Luis M. Ortiz, P.O. Box 4484, Albuquerque, NM, 87196, US

(21) Appl. No.: 10/434,686

(22) Filed: May 9, 2003

(51) Int. Cl. G06F 17/60

(52) U.S. Cl. 705/400

(57) ABSTRACT

Determining the value of services can include the steps of providing subject matter information and at least two scored parameters associated with the subject matter to a professional service value estimator (PSVE) operating in a data processing system, determining the an average score for the at least two scored parameters; determining a economic index associated with the subject matter, and multiplying the average score with the economic index, the result being indicative of the value of services (VPS). A system for determining the value of professional services can include a signal acquisition device for obtaining subject matter information for a matter requiring professional services and at least two scored parameters associated with said subject matter, and a processor for (i) deriving, from the at least two scored parameters and the information, an average score, (ii) determining an economic index associated with the subject matter, and (iii) multiplying the average score with the economic index to determine a value of professional services (VPS). The system can include memory for storing information and determined VPS, network access and means for rendering value and associated data. A computer readable medium having computer readable program code embodied therein. Computer readable program segment directs the reading of service information and associated scoring provided to the computer system. A code segment directs the analysis of service information including determining an average score for the information, which can be based on historical scoring data. A code segment enables the multiplication of an economic index with the average score determined by the system, the result representing the VPS. A code segment can facilitate storage in memory, display, rendering and communication of VPS and associated data.

### TECHNICAL FIELD OF THE INVENTION

The present invention relates to the use of computer-assisted methods and systems for ascertaining, enhancing and/or establishing the value of professional services.

### BACKGROUND

When it comes to managing professional services at most large companies, management for service organizations are usually granted unconditional and unquestioned authority on how they run their departments—as long as the service recipients (company management and in-house clients) are satisfied. This kind of operational management over in-house professional service providers can sometimes result in inefficient organizational operations and the lack of ascertainable value for professional services, which can also translate into inadequacy in the company's and the service providing organization's ability to adequately set an annual budget.

While it is rare to find a commercial organization that will normally pay bills received from private professional organizations without understanding the bill's content, this is exactly what many companies often do when budgeting for “in-house” professional services. Most corporate management are limited in their ability to ascertain the value of its professional organization and its independent contributors because management lacks the availability of effective tools that can identify the nature and value of the services. Value is generally tied to resolution of problems for, or the generation of solutions by, operational entities within the company, and the general effect on cost. Managers are rarely aware of how their administrative and professional operations can drastically impact (positively or negatively) their profitability and overall return on investment (ROI).

Professional organizations are not typically considered profit centers and are classified as general overhead by most companies. Therefore, unlike manufacturing, sales and other revenue generating entities, professional functions and associated organizations do not have the necessary data (e.g., sales) to make a value determination for classical overhead functions such as in-house legal counsel. Resources to differentiate between a $50,000 legal budget needed to work towards the avoidance of a $1,000,000+ liability claim is not readily available to managers so that the value of its overhead functions can be fully appreciated or recognized. The value of the professional services (potentially generating extremely large savings, as in the example) are not presently being provided to management whom are primarily responsible for the allocation of ongoing funding and resources to their professional service functions.

Although computer-aided and standalone systems are known to have been used for the general evaluation of risk, its allocation and transfer functions, as with actuary methodologies used in the insurance industry, they have not been directly employed to establish meaningful value assessments for organic (e.g., “in-house”) professional services. Meanwhile, private professional service enterprises generally also lack meaningful controls for valuing its services. In most industries, customers can generally judge the quality and value of common products and services for themselves. But, with most professional services, recipient-clients are not technically and professional qualified to ascertain the quality or value of services being paid for and received. The lack of understanding and meaningful quality and budgetary controls results in notoriously high levels of client (i.e., management) dissatisfaction with, distrust of or overall lack of appreciation for, professional service providing entities.

The present inventors have recognized through their experience in managing corporate and government legal departments that a need exists for general management to be able to ascertain the value of its in-house professional services. The present inventors believe that the present invention can address the current problem by providing systems and methods for tracking activities and enabling a determination of meaningful value for professional services being provided by organizations that are organic (i.e., in-house) to a company.

### SUMMARY OF THE INVENTION

Systems and methods are provided for determining a estimated monetary value of professional services (VPS). From information input into a system by clients and service providers, an assessment of the estimated value for a matter requiring professional services can be determined and made available to company management.

The methods of this invention are basically divided into two stages: The first stage involves the receipt and validation of basic information collected from professional and their clients regarding a legal matter. The second stage involves the calculation of service value.

In accordance with an aspect of the present invention, a method for determining the value of services includes the steps of providing subject matter information and at least two scored parameters associated with the subject matter to a professional service value estimator (PSVE) module operational within a data processing system, determining an average score for the at least two scored parameters; determining an economic index associated with the subject matter, and multiplying the average score with the economic index, the result being indicative of the estimated value of professional services (VPS).

In accordance with another aspect of the present invention, a system for determining the value of professional services can include a signal acquisition device for obtaining subject matter information for a matter requiring professional services and at least two scored parameters associated with said subject matter, and a processor for (i) deriving, from the at least two scored parameters and the information, an average score, (ii) determining an economic index associated with the subject matter, and (iii) multiplying the average score with the economic index to determine a value of professional services (VPS). The system can include memory for storing information and the determined VPS, network access and a means for rendering or communicating value.

In accordance with yet another aspect of the present invention, a computer program product can be provided for determining the value of professional services. The computer program includes: a computer readable medium having computer readable program code embodied therein, the computer readable program code comprising: computer readable program code segments operable in a computer to enable processing of service information and associated scoring data provided to a computer or computer network by its users. The computer readable program includes: a code segment for analyzing said service information and determining an average score for the information based on the scoring data; a code segment for multiplying a economic index with the average score, the result of the multiplying representing the value of professional services (VPS), and providing the VPS for storage in and retrieval from memory, rendering and network communication.

A determination of value can include not only an examination of historical data but also the evaluation of prospective services, competitor and market projections based on market research, user experience, benchmarking data, statistical data developed through use of the present invention and the use of heuristic rules. Where historical or statistical data is not available, estimates based on the user's experience can also be used until adequate experiential or historical data has been developed and stored in databases associated with or available for access by the computer system implementing the preferred embodiments of the present invention. Due to the mixture of historical and prospective analyses, which can be included as an input in the method of this invention, the value of services may be an amount less than, equal to or even greater than the actual amount realized—a simple estimate.

The present invention can include the use of computer technology and networks, such as a virtual private electronic network (“Network”) accessible through a browser or similar interface. In a preferred embodiment, the present invention is primarily enabled by the use of a Professional Services Valuation Estimator (PSVE) module available to some or all participants associated with initiating, executing, monitoring, and providing controls and statistical data for the workflow of PSVE processes undertaken on behalf of clients. The PSVE can be used by the managing attorneys, primary attorneys, financial officers, comptrollers, accountants, clients, medical personnel, hospital administrators, health plan administrators, consultants, administrative assistants, paralegals, and other “Participants.”

Other features and advantages of the present invention will be apparent to those of ordinary skill in the art upon reference to the following detailed description when taken in conjunction with the accompanying drawings.

### DESCRIPTION OF THE DRAWINGS

For a better understanding of the invention, and to show by way of example how the same may be carried into effect, reference is now made to the detailed description of the invention along with the accompanying figures in which:

FIG. 1 illustrates a block diagram of system components useful in implementing the preferred embodiments of the present invention;

FIG. 2 illustrates a block diagram of alternate system components useful in implementing the preferred embodiments of the present invention;

FIG. 3 illustrates a flow diagram of method steps in accordance with preferred embodiments of the present invention; and

FIG. 4 illustrates a chart containing parameters that can be used in carrying the preferred embodiments of the present invention.

### DETAILED DESCRIPTION OF PREFERRED EMBODIMENTS

While the making and using of various embodiments of the present invention are discussed in detail below, it should be appreciated that the present invention provides other applicable inventive concepts, which can be embodied in a wide variety of specific contexts. The specific embodiments discussed herein are merely illustrative of specific ways to make and use the invention and are not meant to limit the scope of the invention.

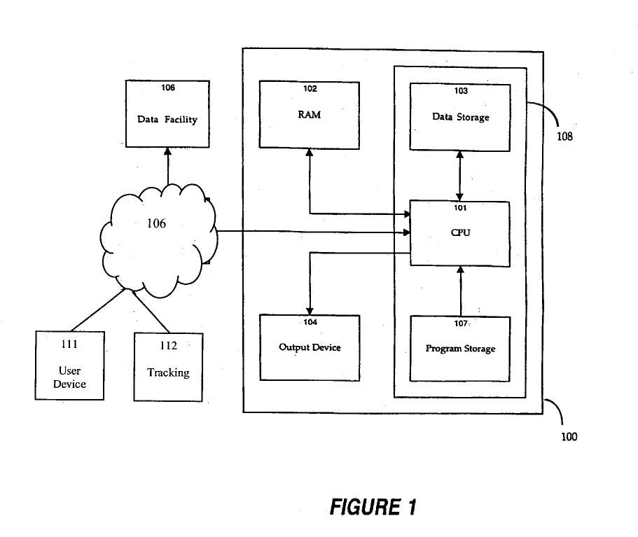

The present invention provides novel methods and systems for estimating the value of professional services. Referring now to FIG. 1, there is shown a block diagram of a typical implementation of a system 100 in accordance with the present invention. Transaction information can be applied to system 100 via data network 105, which can be connected to a historical data facility 106 collecting transaction information from conventional sources such as human-operated terminals 111 and automated transaction tracking systems 112 (e.g., intelligent database or neural network-enhanced database). CPU 101 runs software program instructions stored and retrievable from program storage 107, which directs CPU 101 to perform the various functions of PSVE software. The PSVE software program can be written in the ANSI C language, which can be run on a variety of conventional hardware platforms. In accordance with software program instructions, CPU 101 stores the data obtained from data network 105 in data storage 103, and uses RAM 102 in a conventional manner as a workspace. CPU 101, data storage 103, and program storage 107 can operate together to provide a neural network model 108 from tracking professional service subject matter and assist in developing historical data for future comparison and assessments. After neural network 108 processes the information to develop historical indication of value for professional services, the historical data can be referenced in future valuations conducted using the PSVE.

In the preferred embodiment, CPU 101 can be a mainframe computer, RAM 102 and data storage 103 can be conventional RAM, ROM and disk storage devices, and output device 104 is a conventional rendering means for either printing, transmitting (e.g., email) or displaying results based on results generated by the PSVE software which may be enhanced by input generated and provided by neural network 108, or displaying the results on a video screen using a window-based interface system, or sending the results to a database for later access, or sending a signal dependent on the results to an authorization system (not shown) for further processing.

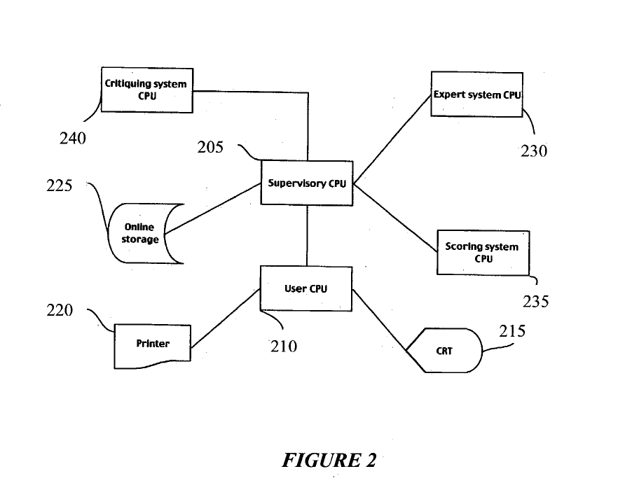

The process of this invention is preferably performed by use of a computer system cooperating with one or more users who supervise and may intervene and at times override conclusions reached by the computer system, although the process may also be performed manually. Another block form overview of the computer system in accordance with a preferred embodiment of the instant invention is shown in FIG. 2. This system can be implemented in the framework of a cooperative computer support network in which users initiate certain actions and make final decisions using information that has been partially computer-processed. The various components of the system can be interconnected to each other via a supervisory central processing unit (CPU) 205 which can be any type of digital or other computing apparatus such as a main frame or mini-computer. Supervisory CPU 205 coordinates, organizes and relays information to and from other components of the system. For each new applicant, the user can manually enter all data necessary for performing the calculations in this invention at user CPU 210. Means for rendering data can include one or more display devices 215 and one or more devices for producing hardcopy documents, such as a printer 220. Data can also be provided through at network connection by methods and systems known in the art. Information can include general subject matter identifying data, as well as legal, structural and financial data specific to the matter, and can also include data related to the industry and markets associated with or affecting the outcome of the matter. Alternatively, data can be entered in an automated fashion by using a scanning device or can also be collected from a secure Internet website by applicants.

Certain types of relevant data, such as project difficulty or novelty can also be stored in databases or Internet website servers external to the computer system utilizing the invention, and the system may also be configured to include facilities for automatically or manually accessing such external databases to retrieve required information. Initially, the entered data can be stored in one or more databases for access and use during processing by any component of a dedicated system. Online storage device 225 can also be provided in the form of offline storage devices or a combination of online and offline devices. Storage device 225 can also store system information in a database format related to a specific industry or market (e.g., data for many different products or services and types of statistical and historical data as will be explained below). Expert system CPU 230 and scoring system CPU 235, both of which can communicate with supervisory CPU 205 can include the interaction of automated support components for a system. Expert system 230 may be a separate computer CPU operating with heuristic rules for solving related problems based on information supplied to it by supervisory CPU 205, which in turn can be derived from other components of the system.

The expert system can perform data management and actuarial modeling of historical and prospective events that may impact the value assigned to services. Scoring system 235 may be provided as another computer CPU that can make use of statistical models to build a scoring function based on associated quantitative input attributes aids in objectively evaluating the value of services. By using this structure of automated components subjective decision-making can be minimized in the asset evaluation process, conclusions are standardized, user-learning time is reduced, quick resolutions of asset queries can be obtained and data tractability can be provided. Critiquing system CPU 240 can compare the reasoning of the user, who may be an asset evaluation officer, as entered at user CPU 210, with computer results generated in the expert and scoring components of the system. A user can be notified through supervisory CPU 205 if it detects a reasoning error. The user can then perform evaluation or re-evaluation tasks him/herself using the information or feedback filtered and refined by supervisory CPU 205. Results and interim system communications can be displayed on device 215 and/or reproduced on printer 220. The computer system can alternatively assume multiple configurations such that, for example, one or more CPU's singly or jointly perform all functions described above, allowing multiple users may be simultaneously accommodated. A feedback loop, and/or artificial intelligence constructs, can be used in the process for comparison of actual outcomes and predictive outcomes that can be derived from scores and heuristic rules set for or assigned by the process. It is well known that Intelligent systems can train themselves over time to assume more and more of the typical functions initially requiring user intervention and do so with an increasing level of accuracy, sensitivity and specificity.

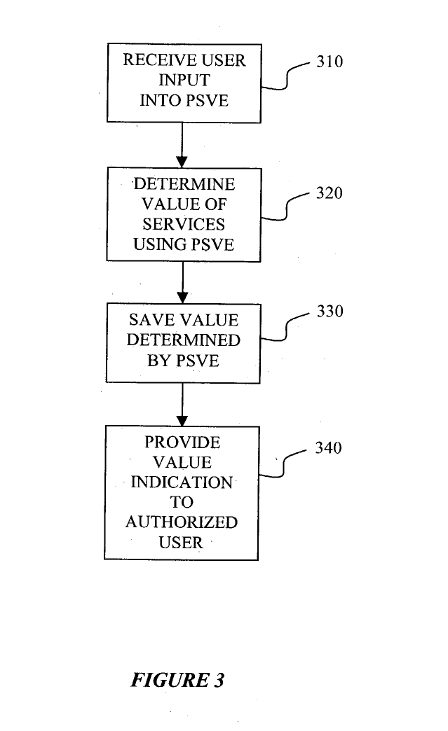

Implementation of the PSVE methods of this invention can be viewed as being generally executed within the system in a two-stage process. Referring to FIG. 3, in the first stage 310, information is gathered from system users (clients and professionals) regarding the service(s) being rendered. In the second stage 320, the data is analyzed and a value is rendered, which is assigned to the service(s) associated with the identified matter. For example, the first stage of the process can be comprised of gathering data from users, wherein the users providing the data are both the service provider (e.g., attorney) and the client (e.g., company manager). In the first stage 310 a preliminary analysis of the general identification of a matter together with scoring parameters relevant to the matter (e.g., priority, response time, exposure, financial) can be received. The second stage 320 of the process is concerned with determining the value of the services based on user input. Once a value of services is determined, the value can be stored 330 for future use by the system and its users to rate future service value request, generating reports and enabling retrieval as indicated in block 340.

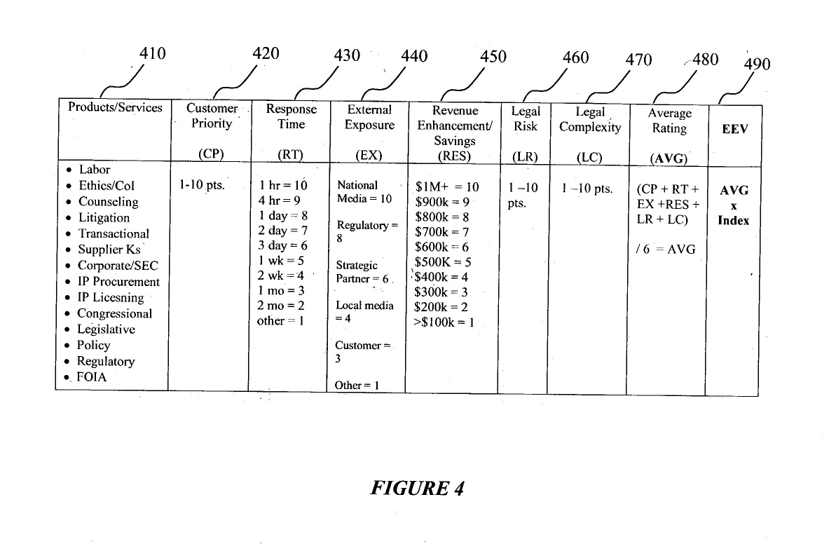

Referring to FIG. 4, a chart 400 is illustrated containing parameters that can be used for identifying a “legal” matter requiring professional services. The chart is being shown as an example only, and the matter types, attributes and rating/point system should not be considered as a limitation of the present invention. Those skilled in the art should appreciate that variations in matter identity and input data can be associated with a matter, include point rating systems and can be used on a case-by-case basis.

Referring to FIG. 4, a first column 410 allows for the selection of a matter type. The list in the column shows several types or categories of popular legal services that are provided to a company by an in-house legal department. For example, a corporate legal department is oftentimes asked to provide assistance for Labor-related matters, Ethics and conflicts-of-interest issues, general legal counseling, litigation support and outside counsel management, transactional (e.g., contract) support, supplier agreement review, SEC and corporate compliance support, intellectual property procurement, licensing and litigation support, congressional interaction (e.g., lobbying), legislative support (drafting proposed legislation), developing reviewing policy, support with regard to compliance with regulatory guidelines, and processing of Freedom of Information Act (FOIA) requests. Based on the teaching herein, it should be appreciated that subject matter related to financial or accounting organizations could replace the list of legal matters. For example, financial audits (internal and external), market analysis, accounting functions, investment support, SEC compliance, etc., are all matters relevant to financial functions of a corporate enterprise.

Column 420 allows the user to assign a priority (CP) to the matter being services. The customer can select, as shown in the example, a number from one to ten, with ten being the highest priority assignable to a matter. Column 430 of the chart allows the user to assign a desired/required response time (RT) to the matter. The shortest amount of time receives the highest rating, whereas the least priority matter receives the lowest rating. Column 440 allows the user to select what may be determined to be the most probable risk of exposure (EX) for the matter. If a matter may receive national media attention, it should receive the highest point, whereas the least risk is assigned the lowest point allowed. Exposure risk is self-explanatory. Column 450 allows the user to select the most probable revenue enhancement or savings (RES) that may be realized by intervention into the matter. RES from Column 450 can be viewed from several perspectives: RES because litigation was avoided, RES because market opportunities are developed, RES because potential liability is reduced or litigation was avoided, RES because strategic intellectual property can be protected, RES because a strategic partner or licensee can be engaged. Therefore, the skilled should appreciate that RES is flexible and is based on the user's subjectivity. Column 460 allows the user to rate the legal risk (LR) for the matter being assigned. It should be appreciated that LR can be changed to financial risk (FR) or business risk (BR) when the system is being used for a service provider other than “legal.” Column 470 allows the user to assign a value for the legal complexity (LC) of the matter. Again, it should be appreciated that financial complexity (FC) and business complexity (BC) are examples of optimal assignments depending on the type of services being rendered. Column 480 illustrates the average (AVG) for inputs from columns 420-470. The average is determined as follows:

AVG=(CP+RT+EX+RES+LR+LC) divided by 7.

As shown in column 490, the average (AVG) is then multiplied by an economic index (AVG×Index) to determine the value of the professional services (VPS). The economic index can represent many different parameters. The economic index can come, for example, from: historical data representing the average costs of like matters; the hourly cost for professional time for like matters, the company's stock price, or the current cost of tangible in the marketplace (e.g., price per ounce of gold). Obviously, more realistic economic indicators can look at recent historical data and benchmarking data to develop an economic indicator.

For one example of an economic indicator that may be used with the present invention, suppose the average hourly cost for professional serving full time in the professional organization will be used. Assume that average hourly costs for a professional, which can be based on the total costs of salary, bonuses, training, benefits and office overhead (e.g., support staff salaries, rent, and other office expenses) associated with maintaining the company's professional staff divided by the number of professionals, is $175/hour. Then assume that the professional will take 25 hours to complete the project. Then an economic indicator can be used that takes into account the cost of the services based on the hourly wages and an estimate of time, which in this case will be the number 4275. A formula and economic indicator can also be devised and used that only represents the cost of a single professional assigned to the matter, which can then compensate for experience level or a particular skill-set.

A close estimate of the value of legal services can now be ascertained using the above-described parameters. For example, suppose the average (AVG) for a fairly complex and high profile legal matter is determined to be seven (7) and is assigned to an attorney in the General Counsel's Office of a corporation. Using the economic index of 4275 (which assumes the 25 hour project estimate), the value of the legal services provided can be estimated to be $29,925. Suppose that a lower priority, low profile problem is determined to have an average of 1.5. Then the cost of legal services using the economic index will be $6263.

Determination of value can include not only an examination of historical data but also the evaluation of prospective services, competition and market projections based on market research, user experience, benchmarking data, statistical data developed using the present invention, and the use of heuristic rules. Where there is insufficient historical or statistical data available, estimates based on the user's experience can also be used until adequate experiential or historical data has been developed and stored in databases available to the computer system implementing the preferred embodiments of the present invention. Because of the mixture of historical and prospective analyses that can be provided as part of any value assessment, the value of services may be an amount less than, equal to or even greater than the actual amount realized.

The present invention includes the use of computer technology and networks, such as a virtual private electronic network (“Network”) accessible through a browser or similar interface. In a preferred embodiment, the present invention is primarily enabled by the use of a Professional Services Valuation Estimator (PSVE) by some or all participants in initiating, executing, monitoring, and providing controls and statistical data for the workflow of PSVE processes undertaken on behalf of clients. The PSVE can be used, for example, by managing attorneys, primary attorneys, financial officers, comptrollers, accountants, clients, medical personnel, hospital management, health plan providers, consultants, administrative assistants, paralegals, and other “Participants.”

A network can typically be provided in the form of an intranet, the Internet, or a combination of networks, and can use standard Internet Protocol (e.g., TCP/IP) or other ubiquitous communications protocols including wireless (e.g., WiFi, Wireless LAN, Bluetooth, 802.11). User participation is enabled by access to the PSVE via a standard, web browser or equivalent, a custom application or its equivalent, or other access technology as may exist for networking functionality, such as wireless/mobile device access, access via an “internet appliance”, or telephone or “videophone” access, or any future equivalents, singly or in combination.

The embodiments and examples set forth herein are presented to best explain the present invention and its practical application and to thereby enable those skilled in the art to make and utilize the invention. However, those skilled in the art will recognize that the foregoing description and examples have been presented for the purpose of illustration and example only. The description as set forth is not intended to be exhaustive or to limit the invention to the precise form disclosed. Many modifications and variations are possible in light of the above teaching without departing from the spirit and scope of the following claims.

What is claimed is:

1. A system for providing the value of services, comprising:
an interface for receiving information associated with a matter requiring services from a service provider; and
a professional service value estimator (PSVE) module for analyzing said information associated with a matter requiring services from a service provider and determining value for said service.

2. The system of claim 1, wherein said information received by said interface includes scores for at least two attributes associated with said information, and wherein said value determined by said PSVE is based on the average of said scores associated with said at least two attributes multiplied by an economic value index.

3. The system of claim 2, wherein said value is determined by the average of said scores for attributes selected from at least two of the following: customer priority, response time, external exposure, revenue enhancement/savings, cost optimization, risk, complexity.

4. The system of claim 1 including a database for storing said information received by said interface and said value determined by the PSVE.

5. The system of claim 4 including a means for rendering at least one of said information and said value.

6. A computer program product for determining the value of professional services, comprising: a computer readable medium having computer readable program code embodied therein, the computer readable program code comprising: computer readable program code which reads service information and associated scoring data provided by a user; a code segment for analyzing said service information and determining an average score for said information using said scoring data; a code segment for multiplying a economic index with said average score to determine the value of professional services (VPS), and providing said VPS for at least one of: storage in memory, rendering, and communication.

7 A method for determining the value of services, the method comprising the steps of:
providing subject matter information and at least two scored parameters associated with said subject matter to a professional service value estimator (PSVE) housed in a data processing system;
determining the an average score for said at least two scored parameters;
determining an economic index associated with said subject matter;
multiplying said average score with said economic index to determine the value of services (VPS).

8. The method of claim 7, further comprising the step of storing said VPS.

9. The method of claim 8, further comprising the step of rendering said VPS.

10. The method of claim 8, further comprising the step of communicating said VPS over a network.

11. The method of claim 7, wherein said scored parameters includes scores associated with at least two attributes for said information provided to the PSVE, and wherein value is determined by said PSVE is based on the average of said scores associated with said at least two attributes multiplied by an economic value index.

12. The method of claim 11, wherein said average of said scores is determined by determining the average score for attributes selected for at least two of the following: customer priority, response time, external exposure, revenue enhancement/savings, cost optimization, risk, complexity.

13. The method of claim 12, further comprising the step of storing said VPS.

14. The method of claim 13, further comprising the step of communicating said VPS to an authorized user.

15. The system of claim 14 including a step of rendering at least one of said information and said value to an authorized user through a network.

16. A system for determining the value of professional services, comprising:
a signal acquisition device for obtaining subject matter information for a matter requiring professional services and at least two scored parameters associated with said subject matter; and
a processor for (i) deriving, from said at least two scored parameters and said subject matter information, an average score, (ii) determining an economic index associated with said subject matter information, and (iii) multiplying said average score with said economic index to determine a value of professional services (VPS).

17. The system of claim 16 further comprising a memory for storing said information and said VPS.

18. The system of claim 17 further comprising network communications for enabling communication of said information and said VPS over a network.

19. The system of claim 18 further comprising a display for displaying said information and said VPS.

20. The system of claim 17 further comprising a printer for rendering said information and said VPS.
